(19) United States
(12) Patent Application Publication
(10) Pub. No.: US 2009/0313127 A1
(43) Pub. Date: Dec. 17, 2009

(54) SYSTEM AND METHOD FOR USING CONTEXTUAL SECTIONS OF WEB PAGE CONTENT FOR SERVING ADVERTISEMENTS IN ONLINE ADVERTISING

(75) Inventors: David Chaiken, Menlo Park, CA (US); Kalyan Kumar Kanuri, Bangalore (IN); Arun Ramanujapuram, Bangalore (IN); Mahesh Tiyyagura, Hyderabad (IN)

Correspondence Address: Law Office of Robert Bolan, P.O. Box 36, Bellevue, WA, 98009, US

(73) Assignee: Yahoo! Inc., Sunnyvale, CA (US)

(21) Appl. No.: 12/137,477

(22) Filed: Jun. 11, 2008

(51) Int. Cl. G06Q 30/00

(52) U.S. Cl. 705/14.72

(57) ABSTRACT

An improved system and method for using contextual sections of web page content for serving advertisements in online advertising is provided. A publisher may use a tool to identify sections of a web page that represent content to be used in contextual advertising. When rendered by a web browser, content from marked sections may be extracted from the web page and sent to an advertisement server for selectively matching advertisements for display to a user. Features may be identified from the content sections and used to select advertisements matching the extracted content of the web page. In particular, the features identified from the content sections may be matched with features designated by advertisers for advertisements. Web page placements may be allocated for advertisements matching the extracted content, and the advertisements may be served for display with the web page.

### FIELD OF THE INVENTION

The invention relates generally to computer systems, and more particularly to an improved system and method for using contextual sections of web page content for serving advertisements in online advertising.

### BACKGROUND OF THE INVENTION

Operators of websites offering online content may manage an inventory of advertisements that may be shown to visitors viewing content of a website. When a user may visit a website, the operator of the website or a third party may choose to show one or more advertisements to the user with the expectation that the user may select an advertisement to buy advertised goods or services. Advertisers may bid to have their advertisement shown to a visitor viewing particular content of the website. Or the operator of the website or third party may choose the advertisement and may generate revenue whenever a visitor may select an advertisement shown while viewing content of the website.

Most current approaches for choosing advertisements that match the content of a requested web page may consider how well the advertisements may match the topic of the content of the web page. Typically, a web crawler would crawl the web page offline and extract features such as keywords for the web page. The features may be stored in an index with the Uniform Resource Locator (URL). Then when a web page was fetched, the features may be used to select an advertisement. Unfortunately, there are web pages users visit which are not crawled. For example, there may be web pages newly created by a publisher that may not yet be crawled. These pages would not have features stored in an index that may be used for selecting an advertisement. There may also be pages like a user login page that receives user input online, and, therefore, such web pages cannot be crawled offline. Other examples include news websites, personalized content, and other content feeds with newly created content. For newly created or dynamically created web pages, there needs to be better optimization in matching advertisements to web pages to reflect the context of the web page content. The communication and latency costs for analyzing the entire web page in real-time are prohibitive. Text summarization techniques have been applied to reduce the overhead of communication and latency costs for dynamic web page content. See for example, Aris Anagnostopoulos, Andrei Z. Broder, Evgeniy Gabrilovich, Vanja Josifovski, and Lance Riedel, Just-in-time Contextual Advertising, CIKM'07, Nov. 6-8, 2007, Lisboa, Portugal.

What is needed is a way to provide more accurate contextual targeting in serving advertisements in online advertising. Such a system and method should protect privacy information, financial information, or other personally identifiable information, yet improve the user experience and increase revenue for advertisers and website operators.

### SUMMARY OF THE INVENTION

Briefly, the present invention provides a system and method for using contextual sections of web page content for serving advertisements in online advertising. A content extractor operably coupled to a web brower may be provided for extracting content sections of a web page marked for selectively matching advertisements for display to a user. Extracted content sections may sent in various embodiments to an advertisement serving engine that may include a feature extractor for identifying features in the marked content sections of the web page. The advertisement serving engine may also include an advertisement matching engine operably coupled to the feature extractor for selecting advertisements by matching features from the content sections of the web page with the features designated by advertisers for advertisements. Advertisements matching the extracted content may be served for display with the web page.

In general, a publisher may use a tool to identify sections of a web page that represent content to be used in contextual advertising. When rendered by a web browser, content from marked sections may be extracted from the web page and sent to an advertisement server for selectively matching advertisements for display to a user. Features may be identified from the content sections and used to select advertisements matching the extracted content of the web page. In particular, the features identified from the content sections may be matched with features designated by advertisers for advertisements. Web page placements may be allocated for advertisements matching the extracted content, and the advertisements may be served for display with the web page.

The present invention may support many applications that may serve advertisements using contextual sections of web page content in online advertising. For example, online content publishing applications may use the present invention to select a list of advertisements that match the contextual sections of web page content for display with content requested by a user. Similarly, ecommerce applications may use the present invention to select a list of advertisements that match the contextual sections of product information on a web page requested by a user. Or online search advertising applications may use the present invention to select a list of advertisements that match the contextual sections of a web page in search results requested by a user. For any of these online applications, the contextual sections of web page content may be used for more accurate contextual targeting in serving advertisements in online advertising.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for using contextual sections of web page content for serving advertisements in online advertising, in accordance with an aspect of the present invention;

FIG. 3 is an illustration depicting in an embodiment a web page displayed by a web browser executing a publisher tool on a client device to mark content;

FIG. 4 is a flowchart generally representing the steps undertaken in one embodiment for using contextual sections of web page content for serving advertisements in online advertising, in accordance with an aspect of the present invention;

FIG. 5 is a flowchart generally representing the steps undertaken in one embodiment on a client for using contextual sections of web page content for serving advertisements in online advertising, in accordance with an aspect of the present invention; and

FIG. 6 is a flowchart generally representing the steps undertaken in one embodiment on a server for using contextual sections of web page content for serving advertisements in online advertising, in accordance with an aspect of the present invention.

### DETAILED DESCRIPTION

### Exemplary Operating Environment

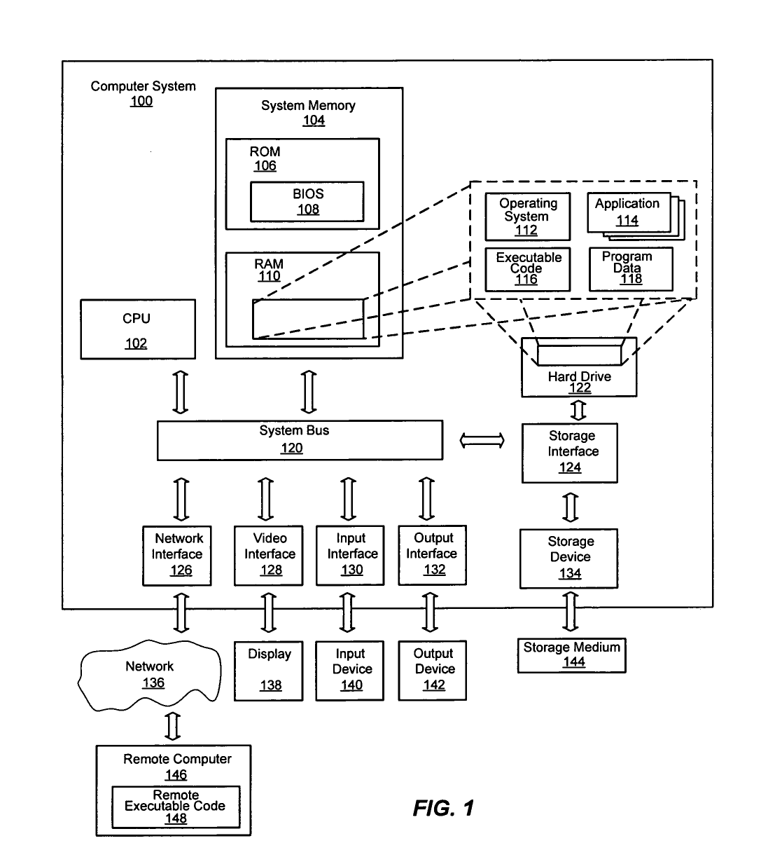

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations. Examples of well known computing systems, environments, and/or configurations that may be suitable for use with the invention include, but are not limited to: personal computers, server computers, hand-held or laptop devices, mobile phones, digital music players, tablet devices, headless servers, multiprocessor systems, microprocessor-based systems, set top boxes, programmable consumer electronics, network PCs, minicomputers, mainframe computers, and distributed computing environments that include any of the above systems or devices.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used. Those skilled in the art will also appreciate that many of the components of the computer system 100 may be implemented within a system-on-a-chip architecture including memory, external interfaces and operating system. System-on-a-chip implementations are common for special purpose hand-held devices, such as mobile phones, digital music players, personal digital assistants and the like.

### Using Contextual Sections of Web Page Content for Serving Advertisements in Online Advertising

The present invention is generally directed towards a system and method for using contextual sections of content for serving advertisements in online advertising. Content, as used herein, may mean any content type including, but not limited to, text, static graphics, video, audio, and rich media such as Macromedia Flash. In general, the content may be described by a markup language including, but not limited to, web pages, RSS feeds, audio playlists, video streams, content designed for mobile phones, and electronic games. In an embodiment, content sections of a web page may be marked for use in serving contextual advertisements. Content from marked sections may then be extracted from a web page when rendered by a client device such as a web browser, and the content may then be sent to an advertisement system for selecting advertisements that match the extracted content. Web page placements may be allocated for advertisements matching the extracted content, and the advertisements may be served for display with the web page. As used herein, a web page placement may mean a location on a web page designated for placing an advertisement for display.

As will be seen, applications that may display advertisements to users who visit a web site, including managed content properties, may use the present invention to serve advertisements that may be matched with relevant content sections of a web page to more accurately reflect the context of the content requested by a user. As will be understood, the various block diagrams, flow charts and scenarios described herein are only examples, and there are many other scenarios to which the present invention will apply.

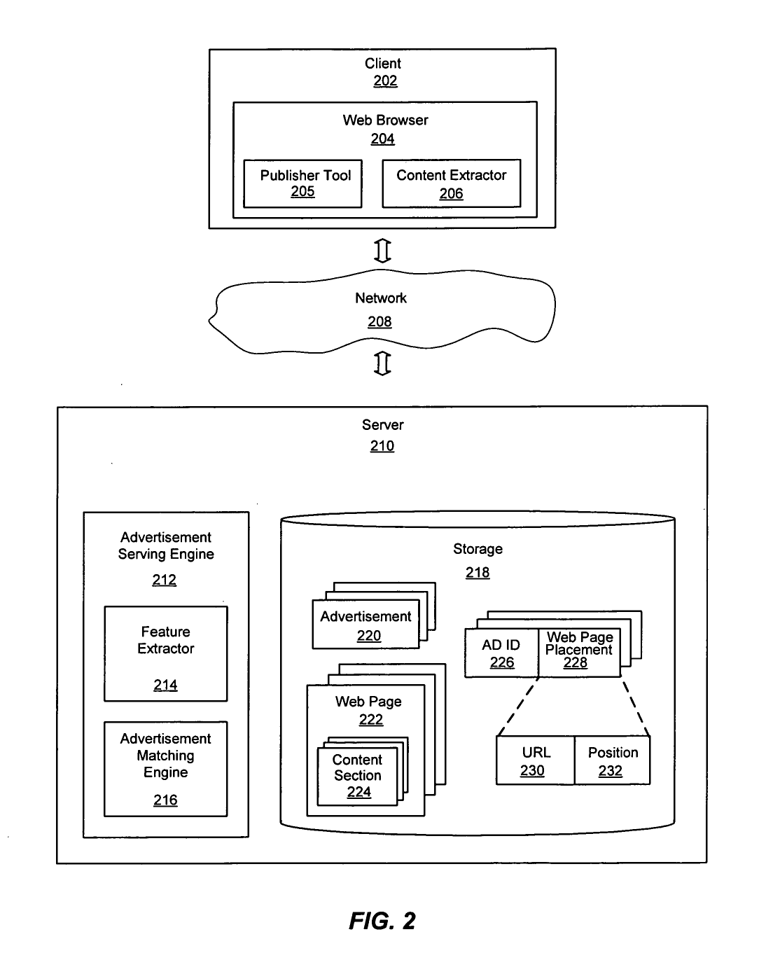

Turning to FIG. 2 of the drawings, there is shown a block diagram generally representing an exemplary architecture of system components for using contextual sections of content for serving advertisements in online advertising. Those skilled in the art will appreciate that present invention may be implemented using other advertising systems including a set top box or handheld device such as mobile phone, personal digital assistant, or digital music player connected to an advertising system. Those skilled in the art will also appreciate that the functionality implemented within the blocks illustrated in the diagram may be implemented as separate components or the functionality of several or all of the blocks may be implemented within a single component. For example, the functionality for the feature extractor 214 may be implemented as a separate component from the advertisement serving engine 212. Or the functionality of the content extractor 206 may be implemented as a separate component from the web browser 204. Moreover, those skilled in the art will appreciate that the functionality implemented within the blocks illustrated in the diagram may be executed on a single computer or distributed across a plurality of computers for execution. Similarly, functionality shown implemented in a component on a client computer may be implemented in a component on a server computer in various embodiments. For example, the functionality of the content extractor 206 may be implemented in the same component as the advertisement serving engine 212 in an embodiment where marker for content sections may be sent to a server where the content sections may be extracted from a web page for analysis.

In various embodiments, a client computer 202 may be operably coupled to one or more servers 210 by a network 208. The client computer 202 may be a computer such as computer system 100 of FIG. 1. The network 208 may be any type of network such as a local area network (LAN), a wide area network (WAN), or other type of network. A web browser 204 may execute on the client computer 202 and may include functionality to receive a request for content which may be input by a user and to send the request to a server to obtain the requested content. The web browser 204 may include a publisher tool 205 to mark content sections of a web page that may be used for selecting advertisements. The web browser 204 may also include a content extractor 206 to extract content of marked sections from a web page when rendered by the web browser, and the content may then be sent to an advertisement system for selecting advertisements that match the extracted content. In general, the web browser 204, the publisher tool 205 and the content extractor 206 may be any type of interpreted or executable software code such as a kernel component, an application program, a script, a linked library, an object with methods, and so forth. In various embodiments, other applications may be used for sending a request for content, including an email application requesting a message from an inbox, an ecommerce application requesting product information, and an online search advertising application requesting search results for a query, and so forth.

The server 210 may be any type of computer system or computing device such as computer system 100 of FIG. 1. In general, the server 210 may provide services for processing requests for content and may include services for providing a list of advertisements to accompany the content requested. In particular, the server 210 may include an advertisement serving engine 212 for serving one or more advertisements for display with the requested content. The advertisement serving engine 212 may include a feature extractor 214 for identifying features in sections of content of a web page and an advertising matching engine 216 for selecting advertisements using features identified in sections of content of a web page for display with the content of the web page. Each of these modules may also be any type of executable software code such as a kernel component, an application program, a linked library, an object with methods, or other type of executable software code.

The server 210 may be operably coupled to computer-readable storage media such as storage 218 that may store any type of advertisements 220 and web pages 222 that may have content sections 224. In an embodiment, an advertisement 220 may be displayed according to a web page placement 228. An advertisement ID 226 associated with an advertisement 220 may be allocated to a web page placement 228 that may include a Uniform Resource Locator (URL) 230 for a web page and a position 232 for displaying an advertisement on the web page. In various embodiments, a web page may be any information that may be addressable by a URL, including a document, an image, audio, and so forth.

There may be many applications which may serve advertisements using contextual sections of content in online advertising. For example, online content publishing applications may use the present invention to select a list of advertisements that match the contextual sections of web page content for display with content requested by a user. Similarly, ecommerce applications may use the present invention to select a list of advertisements that match the contextual sections of product information on a web page requested by a user. Or online search advertising applications may use the present invention to select a list of advertisements that match the contextual sections of a web page in search results requested by a user. For any of these online applications, the contextual sections of content may be used for serving advertisements in online advertising.

In general, selecting contextual sections of content, of a web page for example, may allow more accurate targeting in contextual advertisement by using content sections that are most descriptive of the unique content of the web page and by eliminating other content sections of the web page that are not relevant for matching advertisements. In particular, features such as keywords in sections of a web page such as the main link bar, headers, footers, and templates may dominate content of a web page and otherwise be used along with unique content for selecting an advertisement. Advantageously, just the content of specific sections of a web page may be selected that are most descriptive of the unique content of the web page for use in contextual advertisement targeting.

In an embodiment, a tool may be provided that may take a URL and allow sections of the web page to be marked. A publisher may use the tool to identify sections of the web page that represent content to be used in contextual advertising. For example, there may be a section for a product specification and a section that describes that product itself. The publisher may accordingly identify the sections of the web page that represent the unique content of the web page. The marked sections of content may then be parsed to identify features, and the features may be matched to advertisements to select one or more advertisements. Thus, advertisements may be targeted to relevant content sections of the web page, and other sections of the web page that are not relevant for matching an advertisement are effectively removed from consideration when targeting advertisements to a web page.

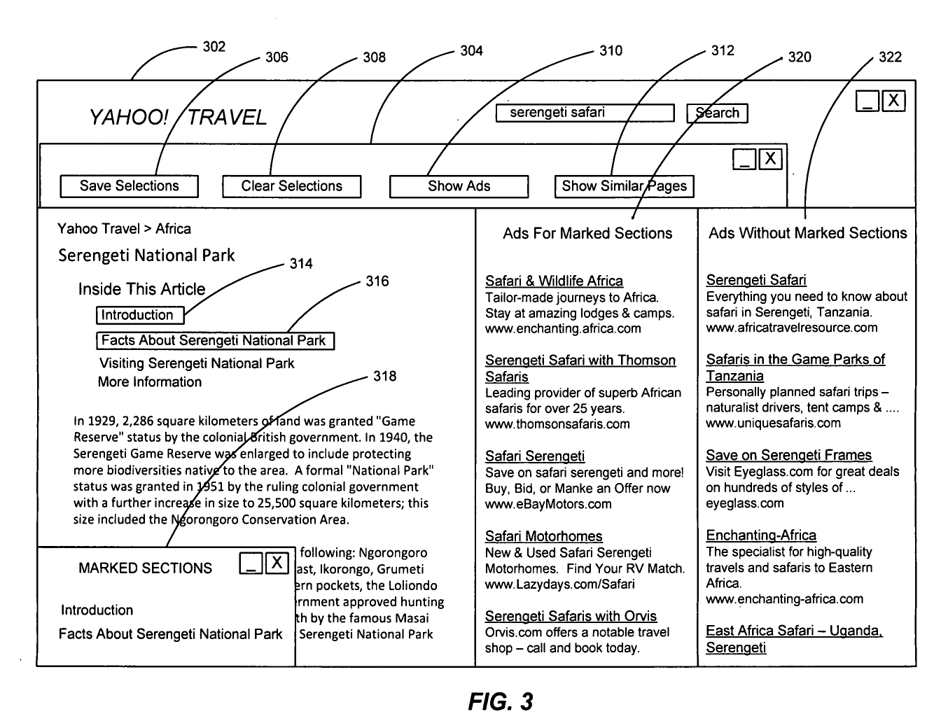

FIG. 3 presents an illustration depicting in an embodiment a web page displayed by a web browser executing a publisher tool on a client device to mark content. A display of a web browser 302 is illustrated in FIG. 3 that may include a toolbar 304 of the publishing tool for a publisher to mark content sections of a web page for selecting advertisements. The toolbar 304 may include several buttons used for marking content sections of a web page and viewing advertisements targeting the content sections marked. For instance, a publisher may choose to select entire content sections such as “Introduction” 314 and “Facts About Serengeti National Park” 316 illustrated in FIG. 3 using an input device such as a mouse, or a publisher may select specific text in a content section in an embodiment. Note that an information box 318 may display a list of marked sections. The content sections selected by the publisher may then be saved by clicking the save selections button 306. And a clear selections button 308 may be clicked to unsave content sections previously saved. Importantly, a publisher may typically mark sections of a single page among several pages of the website with a similar page structure, and the content sections on the other pages with the similar structure may be automatically marked. For example, a publisher may mark an content section such as “Introduction” on a page about travel in Paris, and corresponding content sections on pages about travel for other cities on the website may be automatically be marked.

The toolbar 304 may also include a show ads button 310 that may be clicked to display advertisements targeted to the content sections marked, such as the advertisements illustrated in the display area of FIG. 3 entitled “Ads for Marked Sections” 320. In various embodiments, there may also be shown in an adjacent display area advertisements selected without the content sections marked, such as the display area entitled “Ads Without Marked Sections” 322. This may allow a publisher to see changes in advertisements selected by an advertisement system based upon content sections marked. Moreover, the toolbar 304 may also include a show similar pages button 312 that may be clicked to display another web page from the publisher's website that may also show the advertisements targeted to corresponding content sections marked by the publisher and advertisements selected without the corresponding content sections marked. Advantageously, the publisher tool may allow a publisher to mark a section that appears on each web page in a website once for all web pages in the website. And the show similar pages button 312 may be clicked to visually compare the difference in advertisements selected with and without marked sections.

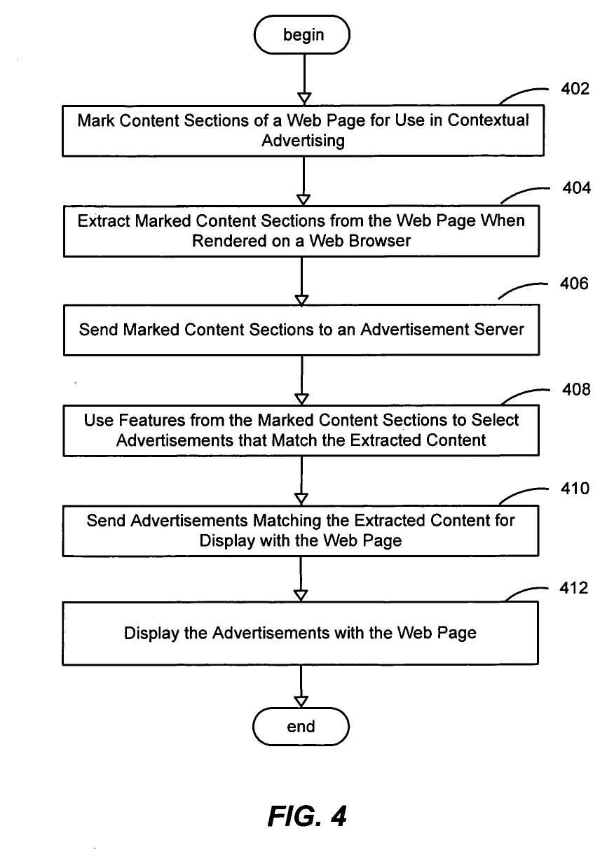

FIG. 4 presents a flowchart generally representing the steps undertaken in one embodiment for using contextual sections of web page content for serving advertisements in online advertising. At step 402, content sections of a web page may be marked for use in serving contextual advertisements. In an embodiment, sections of a web page may be marked, for instance using a publishing tool as described in conjunction with FIG. 3 above, and the location of each marked section may be stored in an annotated segments file or annotation specification. At step 404, content from marked sections may be extracted from the web page when rendered by the browser, and the content may then be sent to an advertisement server at step 406. The browser may look up the markers for each section and extract the content to send to an advertisement server for selecting advertisements for the web page.

At step 408, the features from the marked content sections may be used to select advertisements that match the extracted content. For example, each advertiser may designate features such as keywords that may be used for matching their advertisement to content of a web page, and these features may be matched with features extracted from the marked content sections of a web page to select advertisements. Advertisements matching the extracted content may then be sent at step 410 for display with the web page. And the advertisements may be displayed with the web page at step 412.

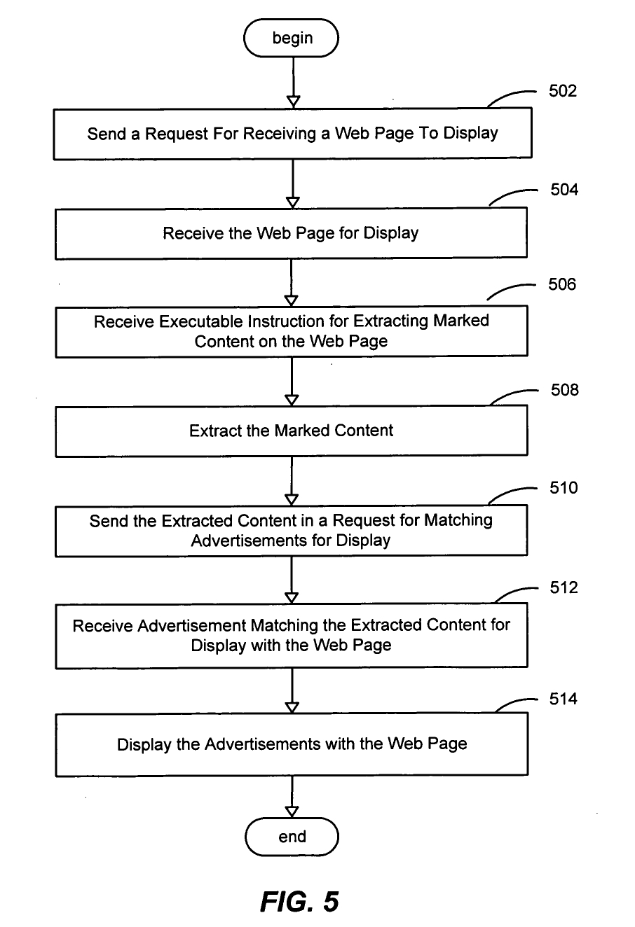

FIG. 5 presents a flowchart generally representing the steps undertaken in one embodiment on a client for using contextual sections of web page content for serving advertisements in online advertising. At step 502, a request for receiving a web page for display may be sent by a client, and the web page may be received by the client at step 504 for display. In an embodiment, the client may also send a request, for example, to an advertisement server to send executable instructions, such as JavaScript, for extracting contextual sections of web page content for serving advertisements. Accordingly, executable instructions may be received at step 506 for extracting marked content from a web page. In various other embodiments, the client may already store executable instructions for extracting contextual sections of web page content for serving advertisements, and the client may request addresses of marked content sections of a web page in order to extract context sections to send to an advertisement system.

At step 508, marked content may be extracted from the web page. In an embodiment, the content may be extracted by the client and sent to an advertising server. In various other embodiments, the markers indicating the content may be sent to the advertising server and the advertising server may extract the content from the web page for the marked sections. Advertisements matching the content for the marked sections of the web page may be received at step 512 by the client and displayed at step 514 with the web page by a web browser, for instance.

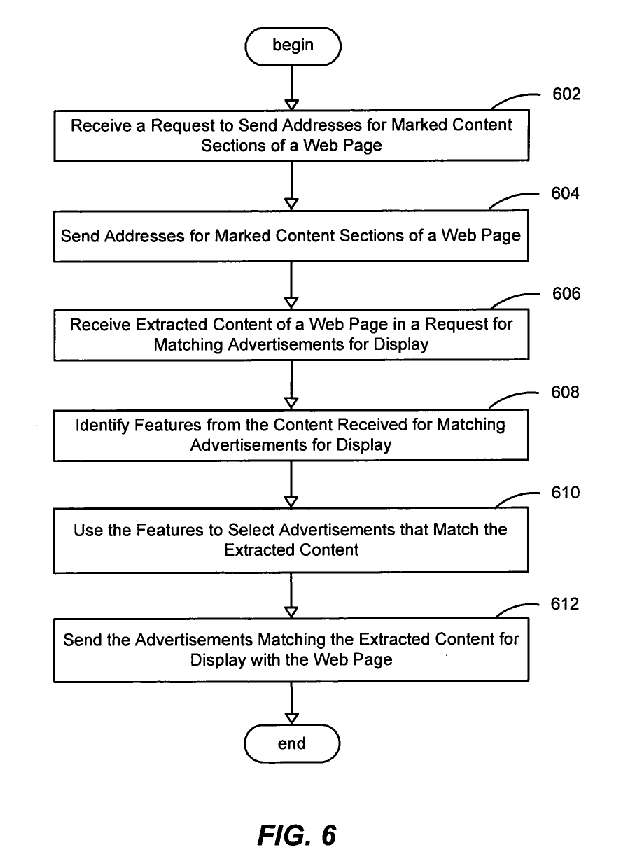

FIG. 6 presents a flowchart generally representing the steps undertaken in one embodiment on a server for using contextual sections of web page content for serving advertisements in online advertising. At step 602, a request to serve addresses of marked content sections of a web page may be received by an advertisement serving engine. In an embodiment, the addresses may represent the location of each marked content section of a web page. For instance, a web page may be an HTML document represented by a Document Object Model (DOM) tree where each node in the DOM tree corresponds to an HTML content section. Each DOM node may be uniquely addressable using the path from the root of the DOM tree to the node of the HTML content section. At step 604, a request to serve advertisements may be received, for instance, with extracted content of a web page by an advertisement serving engine. For example, a request sent from a web browser to a server for advertisements matching extracted content of a web page may be received by an advertisement serving engine along with the extracted content of the web page. Or, the request sent may include a set of features representing the marked content sections of the web page. In various embodiments, the location of each marked section may instead be sent with the request. For instance, the path from the root of a DOM tree to the node of each marked HTML content section may be sent with the request to serve advertisements and an advertisement serving engine may use this path to extract the content of the marked section.

At step 606, features may be identified from the content sections for selecting matching advertisements, and the features may be used at step 608 to select advertisements matching the extracted content of the web page. For an online publishing advertising application, features designated by each advertiser may be used for matching their advertisement to content of a web page by matching the features designated by an advertiser with features extracted from the marked content sections of a web page. Or for an email application, features extracted from content sections of the email may be matched with features extracted from the marked content sections of a web page to select advertisements.

At step 610, web page placements may be allocated for the advertisements that match the content sections of the web page and the advertisement may be served for display in the allocated web page placements. For an online publishing advertising application, web page placements may be allocated for displaying advertisements along with the content requested. Or for an email advertising application, web page placements may be allocated in designated display areas of the email messages page displayed to a user.

Thus the present invention may be used by applications that may display advertisements to users who visit a website, including managed content properties, to serve advertisements that may be matched with relevant content sections of a web page to more accurately reflect the context of the content requested by a user. Advantageously, the system and method may reduce the content parsed to identify features used for selecting advertisements. It may also be used to eliminate features that may be in other sections of the content that are not relevant for matching an advertisement. In various embodiments, content sections may be marked to indicate that the content sections should not be sent or analyzed because the sections may include privacy information, financial information, or other personally identifiable information that should not be sent or analyzed for contextual advertising. As a result, more accurate targeting may be achieved in contextual advertisement by using content sections that are most descriptive of the unique content and by eliminating other content sections that are not relevant for matching advertisements. Thus, the present invention may improve the quality of contextual advertisement placements in online advertising applications.

In addition to a publisher marking content sections of any content described by a markup language, it will be appreciated that content sections may also be marked in various embodiments by a user, an automated software agent, or website operators who may manage an inventory of advertisements that may be shown to visitors viewing content of a website. Any type of computing device may use the present invention to transmit marked content sections for selectively matching advertisements for display to a user. When content may be rendered by a client device, content from marked sections may be extracted and sent to an advertisement server for selectively matching advertisements for display to a user. The present invention may mark content of any type including, but not limited to, text, static graphics, video, audio, and rich media such as Macromedia Flash. Furthermore, various mechanisms may be used for transmitting content of marked sections to an advertising system, including user agent extraction, data feeds and crawling of content to identify marked sections. Moreover, just the marked content sections may be transmitted to an advertising system or any subset of content may be transmitted, including marked content sections.

As can be seen from the foregoing detailed description, the present invention provides an improved system and method for using contextual sections for serving advertisements in online advertising. A publisher may use a tool to identify the sections of the content that represent the unique content to be used in contextual advertising. The marked content sections of a web page, for example, may be used to identify advertisements that match the context of the content of the web page. In an application, the marked sections of content may be parsed to identify features, and the features may be matched with features associated with advertisements to select one or more advertisements. Online content publishing applications may use the present invention to select a list of advertisements that match the contextual sections of web page content for display with content requested by a user. Similarly, ecommerce applications may use the present invention to select a list of advertisements that match the contextual sections of product information on a web page requested by a user. Or online search advertising applications may use the present invention to select a list of advertisements that match the contextual sections of a web page in search results requested by a user. Accordingly, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for online advertising, comprising:
a content extractor for extracting at least one content section of content marked for selectively matching at least one feature associated with an advertisement for display to a user;
a feature extractor operably coupled to the content extractor for identifying a plurality of features from the at least one content section of the web page marked for selectively matching the at least one feature associated with the advertisement for display to the user; and
an advertisement matching engine operably coupled to the feature extractor for selecting the advertisement by matching the at least one feature of the plurality of features from the at least one content section of the content with the at least one feature associated with the advertisement.

2. The system of claim 1 further comprising an advertising serving engine for allocating a web page placement for display of the advertisement selected by matching the at least one feature of the plurality of features from the at least one content section of the content with the at least one feature associated with the advertisement.

3. The system of claim 2 further comprising a web browser operably coupled to the advertising serving engine for receiving the advertisement allocated the web page placement for display to the user.

4. A computer-readable medium having computer-executable components comprising the system of claim 1.

5. A computer-implemented method for online advertising, comprising:
receiving at least one content section of content marked for selectively matching at least one feature associated with an advertisement for display to a user;
identifying a plurality of features from the at least one content section of the content marked for selectively matching the at least one feature associated with the advertisement for display to the user;
selecting the advertisement by matching the at least one feature of the plurality of features from the at least one content section of the content with the at least one feature associated with the advertisement; and
serving the advertisement for display with the content.

6. The method of claim 5 further comprising sending executable instructions for extracting the at least one content section of the content marked for selectively matching the at least one feature associated with the advertisement for display to the user.

7. The method of claim 5 further comprising extracting the at least one content section of the content marked for selectively matching the at least one feature associated with the advertisement for display to the user.

8. The method of claim 5 further comprising receiving the at least one feature associated with the advertisement for display to the user.

9. The method of claim 5 further comprising marking the at least one content section of the content for selectively matching the at least one feature associated with the advertisement for display to the user.

10. The method of claim 9 wherein marking the at least one content section of the content for selectively matching the at least one feature associated with the advertisement for display to the user comprises storing the location of each marked section in an annotated segments file.

11. The method of claim 5 further comprising receiving executable instructions for extracting the at least one content section of the content marked for selectively matching the at least one feature associated with the advertisement for display to the user.

12. The method of claim 5 further comprising sending the at least one content section of the content for selectively matching the at least one feature associated with the advertisement for display to the user.

13. The method of claim 5 further comprising sending markers indicating a location of at least one content section of the content for selectively matching the at least one feature associated with the advertisement for display to the user.

14. The method of claim 5 further comprising receiving the advertisement selected by matching at least one feature of the plurality of features from the at least one content section of the content with the at least one feature associated with the advertisement.

15. The method of claim 5 wherein selecting the advertisement by matching at least one feature of the plurality of features from the at least one content section of the content with the at least one feature associated with the advertisement comprises performing a search for a frequency of the at least one feature associated with the advertisement in the plurality of the features from the at least one content section of the content.

16. A computer-readable medium having computer-executable instructions for performing the method of claim 5.

17. A computer system for online advertising, comprising:
means for sending a request to serve a web page with at least one content section of the web page marked for selectively matching at least one feature associated with an advertisement for display to a user;
means for receiving the web page for display by the web browser;
means for sending a request for selecting the advertisement by matching the at least one feature associated with the advertisement with a plurality of features from the at least one content section of the web page;
means for receiving the advertisement selected by matching the at least one feature associated with the advertisement with a plurality of features from the at least one content section of the web page; and
means for displaying the advertisement with content of the web page.

18. The computer system of claim 17 wherein the means for sending the request for selecting the advertisement by matching the at least one feature associated with the advertisement with the plurality of features from the at least one content section of the web page comprising means for sending the at least one content section of the web page to extract the plurality of the features.

19. The computer system of claim 17 further comprising means for extracting the at least one content section of the web page marked for selectively matching the at least one feature associated with the advertisement for display to the user.

20. The computer system of claim 17 further comprising means for marking the at least one content section of the web page for selectively matching the at least one feature associated with the advertisement for display to the user.
